(19) United States
(12) Patent Application Publication
(10) Pub. No.: US 2008/0269043 A1
(43) Pub. Date: Oct. 30, 2008

(54) Ceramic Insulating Material and Sensor Element Containing a Ceramic Insulating Material

(76) Inventors: Thomas Wahl, Pforzheim (DE); Ulrich Eisele, Stuttgart (DE); Thomas Koehler, Stuttgart (DE); Bernd Schumann, Rutesheim (DE); Karl-Hermann Friese, Leonberg (DE); Juergen Sindel, Vaihingen/Enz (DE); Stefan Nufer, Stuttgart (DE); Frank Buse, Karlsruhe (DE)

Correspondence Address: KENYON & KENYON LLP, ONE BROADWAY, NEW YORK, NY, 10004, US

(21) Appl. No.: 11/667,867

(22) PCT Filed: Nov. 9, 2005
(86) PCT No.: PCT/EP05/55833

§ 371 Date: Mar. 5, 2008

(30) Foreign Application Priority Data
Nov. 16, 2004 (DE) 102004055239.8

(51) Int. Cl. C04B 35/10

(52) U.S. Cl. 501/136; 501/153; 501/135

(57) ABSTRACT

A ceramic insulating material, in particular for sensor elements for determining the concentration of gas components in gas mixtures, is based on an alkaline earth-containing ceramic. The insulating material contains a hexaaluminate of the alkaline earth metal and at least one mixed compound of the alkaline earth metal with an acid oxide, the molar ratio of hexaaluminate to the sum of mixed compounds in the insulating material being 1.3 to 4.0.

### FIELD OF THE INVENTION

The present invention relates to a ceramic insulating material in particular for sensor elements for determining the concentration of gas components in gas mixtures, a method for its manufacture, and a sensor element containing a ceramic insulating material as recited in the preambles of the independent claims.

### BACKGROUND INFORMATION

Nowadays exhaust gas sensors used for detecting gas components in combustion gas mixtures of motor vehicle internal combustion engines typically contain ceramic sensor elements which are manufactured as laminates from zirconium dioxide films, for example. Functional layers are applied onto unsintered zirconium dioxide films in a thick-layer method by silk screening and these layers are subsequently sintered. Since the ceramic films have a sufficient electrical conductivity and ion conductivity only at higher temperatures, which is indispensable for the electrochemical operation of ceramic sensor elements, the sensor elements have one or more heating elements which heat the sensor element to typical operating temperatures of over 400° C. Aluminum oxide layers are typically used for the insulation of heating elements of this type. Aluminum oxide has a high insulating capability, allowing injection of the currents occurring within the heating element into the measuring signals of the electrochemical sensor element to be effectively prevented. However, if the ceramic layers of the sensor element contain contaminants such as, for example, silicon dioxide, Ca ions, Mg ions, or alkaline ions, the insulation capability of the aluminum oxide is considerably reduced. This is caused by diffusion processes at the grain boundaries or in the glass phases between the aluminum oxide particles. Another reason may be seen in a phase conversion; thus, aluminum oxide reacts in the presence of sodium ions, for example, forming sodium beta aluminate, which is considered an ion conductor.

These processes enhancing the conductivity of the heater insulation may be largely suppressed by adding suitable barium compounds. In this case, barium hexaaluminates are formed, which, although they are almost isotypical with sodium beta aluminate, are, contrary to the latter, good electrical insulators. The barium ions added, however, are not firmly anchored in these structures and have a slight residual mobility. There is the possibility in this case that barium migrates into the resistor printed conductor of the heating element and reacts with the platinum that exists there to form barium platinates. This results in an undesirable increase in the electrical resistance of the resistor printed conductor of the heating element.

Such an insulating material is discussed, for example, in German Patent Application DE 102 12 018 A1, which contains an aluminum oxide material, in addition to barium sulfate, a barium aluminate, a barium hexaaluminate, celsian, or other alkaline earth metal compounds. However, even this insulating material has a certain residual mobility for barium ions.

### SUMMARY OF THE INVENTION

An object of the exemplary embodiment and/or exemplary method of the present invention is to provide a ceramic insulating material, in particular for sensor elements, for determining gases in gas mixtures, the ceramic insulating material having such a reduced mobility for the alkaline earth compounds contained that a neighboring ceramic or non-ceramic material is not impaired by alkaline earth metal ions diffusing thereinto.

With the ceramic insulating material and the method for its manufacture having the characteristic features described herein the object of the exemplary embodiment and/or exemplary method of the present invention is achieved in an advantageous manner. The ceramic insulating material exhibits a largely constant high electrical resistance in long-term operation and is characterized by a low mobility of the alkaline earth ions contained in the insulating material.

This is achieved in particular in that the insulating material contains a hexaaluminate of the corresponding alkaline earth metal and at least one mixed compound of the alkaline earth metal with an acid oxide, the molar ratio of hexaaluminate to the sum of mixed compounds being 1.3 to 4.0. The hexaaluminate and the mixed compound contained in the insulating layer form separate phases within the material.

The measures recited in the subclaims make advantageous improvements on and refinements of the insulating material and the method for its manufacture specified in the independent claims possible.

It is thus advantageous if the ceramic insulating material is based on aluminum oxide and contains celsian and/or barium zirconate as a mixed compound. While aluminum oxide is characterized by a particularly high electrical resistance, celsian and barium zirconate, together with an alkaline earth hexaaluminate, prevent diffusion processes of alkaline earth ions.

In an exemplary embodiment of the present invention, the ceramic insulating material is integrated into an appropriate sensor element as the insulation of a heating element. It is advantageous in particular from the cost point of view if the insulation of the heating element is designed as a multilayer insulation, part of the layers being made of the above-described ceramic insulating material and another part of the layers being made of aluminum oxide.

### BRIEF DESCRIPTION OF THE DRAWINGS

FIG. 1 shows a graph of the increase in the electrical resistance of a heating element containing a ceramic, barium-containing insulating material in long-term operation in percent, and the resulting degree of injection of heater currents into a measuring signal of a sensor element in mV plotted against the silicon dioxide content in the ceramic insulating material.

FIG. 2 schematically shows the structure of a ceramic insulating material according to the exemplary embodiment and/or exemplary method of the present invention.

FIG. 3 schematically shows cross sections through sensor elements according to an exemplary embodiment whose heater insulation is at least partly made of the ceramic insulating material according to the exemplary embodiment and/or exemplary method of the present invention.

FIG. 4 schematically shows cross sections through sensor elements according to another exemplary embodiment whose heater insulation is at least partly made of the ceramic insulating material according to the exemplary embodiment and/or exemplary method of the present invention.

### DETAILED DESCRIPTION

The ceramic insulating material may include aluminum oxide as the ceramic base material, for example, in the form of a aluminum oxide (corundum). Aluminum oxide has a high electrical resistance, which, however, may be impaired in the presence of contaminants such as described previously. A gradual decrease in the electrical resistance of the ceramic insulating material caused thereby may be prevented by the addition of barium ions. However, this results in the problems that have also been mentioned previously regarding the mobility of barium ions in the ceramic matrix. This problem is solved by adding or producing barium hexaaluminate and at least one mixed barium compound in a predefined mixing ratio. The mixed barium compound is produced via the reaction of barium oxide, barium carbonate or barium sulfate with a so-called acid oxide, which may be during the manufacture of the ceramic insulating material.

The term acid oxides is applied to element oxides which exhibit an acid reaction under suitable conditions in water or are suitable for absorption of bases. These are, in particular compounds such as SiO₂, Nb₂O₅, Ta₂O₅, ZrO₂, HfO₂, V₂O₅, P₂O₅, and/or TiO₂

For example, if barium oxide and silicon dioxide are added to the initial mixture for producing the ceramic insulating material, at suitable mixing ratios celsian is obtained as the mixed compound. If additionally or alternatively zirconium dioxide is used as the acid oxide, in the presence of barium oxide, barium zirconate is formed as the mixed compound. If the initial mixture contains aluminum oxide, part of the barium oxide reacts with aluminum oxide to form barium hexaaluminate, which has a constant high electrical resistance. The mixed compound which is also obtained prevents barium ions which are not sufficiently firmly anchored from being captured.

The structure of a ceramic insulating material produced in this way is schematically illustrated in FIG. 2. Ceramic insulating material 10 includes separate crystalline phases. These are, as the main component, an α-Al₂O₃ phase 12 and crystals of barium hexaaluminate 14 and, may be next to the barium hexaaluminate crystals, a phase of a barium-containing mixed compound 16, which contains celsian, mixed oxides of barium oxide and silicon dioxide or tertiary phases of barium oxide, aluminum oxide, and silicon dioxide, optionally with the addition of barium zirconate. Barium-containing mixed compound 16 may, however, additionally or alternatively also contain other acid oxides such as Nb₂O₅, Ta₂O₅, ZrO₂, HfO₂, V₂O₅, P₂O₅, and/or TiO₂, optionally with the addition of aluminum oxide. The existence of barium-containing mixed compound 16 at the grain boundaries of the barium hexaaluminate or aluminum oxide phases is of special advantage.

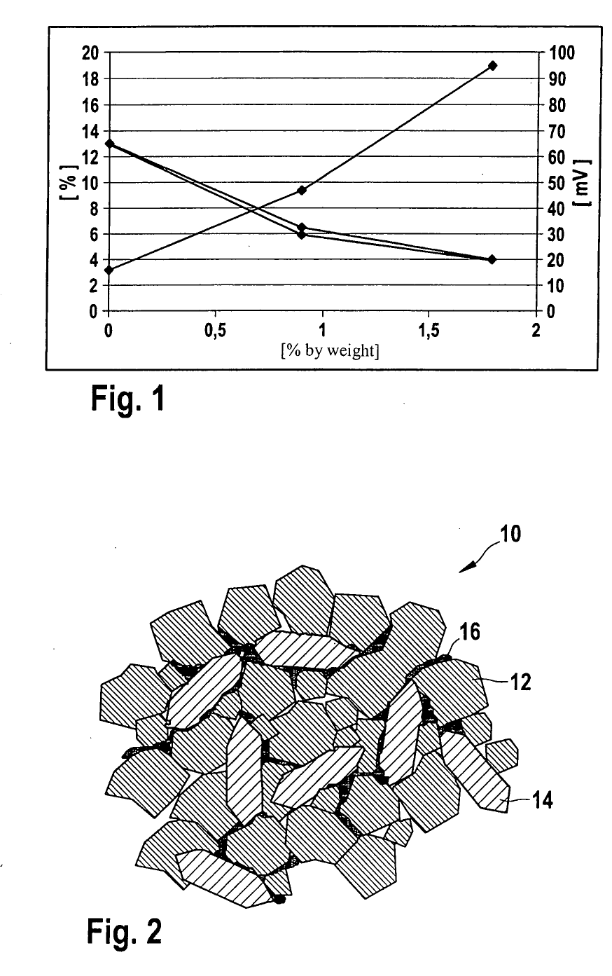

The existence of the mixed compound in the ceramic matrix of the insulating material has a pronounced effect on the magnitude of the resulting electrical resistance of a heating element containing the insulating material. This is illustrated in FIG. 1, which shows a graph of the increase in the electrical resistance of the heating element in long-term operation plotted against the silicon dioxide content in the insulating material in percent by weight and a graph of the injection of measuring signals (heater currents) in mV of the electric heating element insulated by the insulating material into the measuring signal of a corresponding sensor element.

The long-term test was simulated by heating a sensor element containing the insulating material with the aid of its integrated heating element to a surface temperature of approximately 1000° C. within 9 seconds and subsequently cooling kit to room temperature. This cycle was repeated 35,000 times.

The tested insulating material is produced on the basis of a barium-containing aluminum oxide. It has been found that by adding silicon dioxide to the heater insulation with the formation of barium hexaaluminate and at least one mixed compound made up of barium oxide and silicon dioxide, a clearly smaller increase in the electrical resistance of the heating element in long-term operation is observed with an increasing silicon dioxide content. However, the sensor measuring signals are increasingly affected to a similar degree by injections of the currents flowing through the heating element into the measuring signal. The proportion of silicon dioxide as an acid oxide is therefore selected in such a way that, on the one hand, a slight increase in the electrical resistance of the heating element is observed in long-term operation and, on the other hand, pronounced injections of heater currents into the measuring signal of the sensor element are avoided. This is the case in particular when the molar ratio of barium hexaaluminate to mixed compound contents in the ceramic insulating material is selected to be in a range of 1.3 to 4.0.

The ceramic insulating material is manufactured by producing an initial mixture of barium oxide, aluminum oxide, and one or more acid oxides. This initial mixture includes:

| | |
|---|---|
| BaO, BaSO₄ or BaCO₃: | 1-15 molar %, which may be 3-7 |
| | molar % |
| Acid oxide: | 0.5-10 molar %, which may be 1-5 |
| | molar % |
| Al₂O₃: | balance |

In the resulting insulating material, the acid oxide or oxides is/are present in a mixed phase with barium oxide. If silicon dioxide is selected as the acid oxide, celsian (BaAl₂Si₂O₈) is formed as the mixed phase or another binary or ternary phase containing barium oxide, aluminum oxide, and silicon dioxide. The excess barium oxide which is not bound in the mixed phase(s) is primarily present as barium hexaaluminate. Barium hexaaluminate performs the function of an alkali ion interceptor in the resulting insulating material. The mixed compound (celsian) is not suitable for this purpose. In contrast, the celsian phase has the function of suppressing the relatively high, undesirable mobility of barium ions within the ceramic matrix by forming a layer that is impermeable to barium ions and may be distributed at the grain boundaries of the barium hexaaluminate and aluminum oxide. One disadvantage of the celsian phase is that it has an unfavorably high electrical conductivity. This underscores the importance of a suitable barium hexaaluminate to mixed compound ratio, since in this way the electrical conductivity and the mobility of the barium ions may be held at a sufficiently low level.

Two exemplary compositions of ceramic insulating materials are presented below:

| | | |
|---|---|---|
| BaO: | 5.5% | by weight |
| SiO₂: | 1.5% | by weight |
| Al₂O₃: | 93.0% | by weight |

These are present in the ceramic in the following phases next to each other:

| | | | | | |
|---|---|---|---|---|---|
| α-Al₂O₃ | corundum | 95.5 | molar % | 77.4% | by weight |
| BaAl₂Si₂O₈ | celsian | 1.6 | molar % | 4.8% | by weight |
| BaAl₁₂O₁₉ | barium | 2.9 | molar % | 17.8% | by weight |
| | hexaaluminate | | | | |

The resulting ratio of molar equivalents of barium hexaaluminate to BaAl₂Si₂O₈ is 1.8.

A second exemplary composition of a ceramic insulating material is the following:

| | | |
|---|---|---|
| BaO: | 8.8% | by weight |
| SiO₂: | 1.5% | by weight |
| ZrO₂: | 0.7% | by weight |
| Al₂O₃: | 89.0% | by weight |

These are present in the ceramic in the following phases next to each other:

| | | | | | |
|---|---|---|---|---|---|
| α-Al₂O₃ | corundum | 91.7 | molar % | 64.1% | by weight |
| BaAl₂Si₂O₈ | celsian | 1.9 | molar % | 4.8% | by weight |
| BaAl₁₂O₁₉ | barium | 5.6 | molar % | 29.5% | by weight |
| | hexaaluminate | | | | |
| BaZrO₃ | barium | 0.8 | molar % | 1.6% | by weight |
| | zirconate | | | | |

The resulting ratio of molar equivalents of barium hexaaluminate to the sum of BaAl₂Si₂O₈ and BaZrO₃ is 2.1.

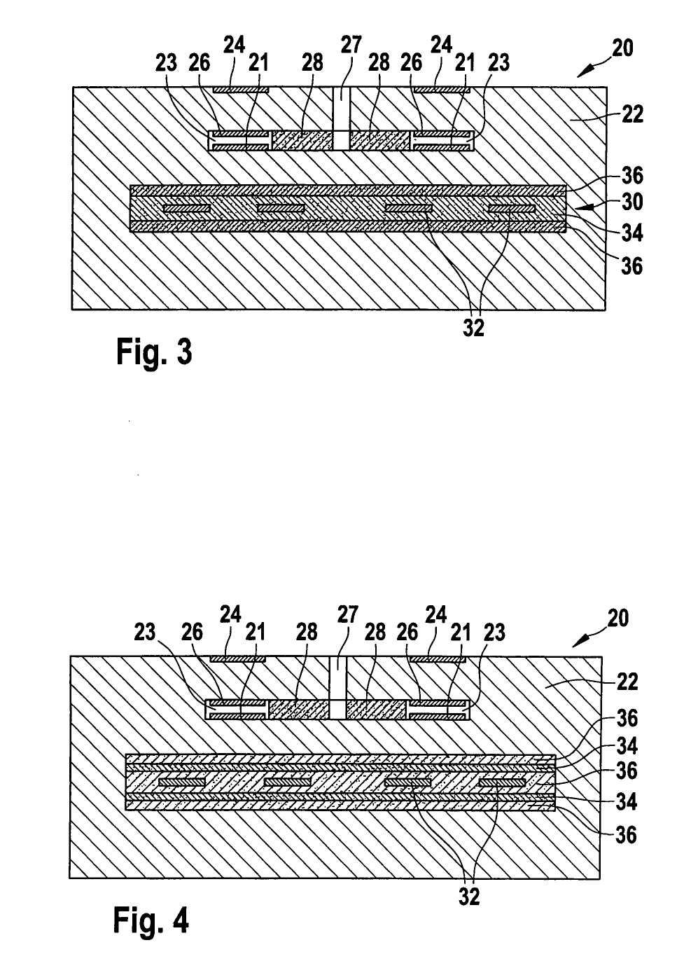

FIG. 3 shows, as an example, a sensor element 20 which includes a heating element 30 whose insulation is at least partly formed by the ceramic insulating material.

The sensor element shown is used, for example, for measuring the oxygen content in exhaust gases of internal combustion engines and has, for example, an oxygen ion-conducting solid electrolyte material 22, for example, in the form of a layered structure. The solid electrolyte layers are designed as ceramic films and form a planar ceramic body. The integrated form of the planar ceramic body of sensor element 20 is manufactured, as known, by laminating together the ceramic films imprinted with functional layers and subsequently sintering the laminated structure. An oxygen ion-conducting ceramic material such as ZrO₂ partly or fully stabilized with Y₂O₃ is used as the solid electrolyte material.

Sensor element 20 contains a measuring gas space 23, which may have an annular design and includes, for example, in a further layer level, a reference air channel (not illustrated) whose one end is led out of the planar body of sensor element 20 and is exposed to the surrounding atmosphere.

An external pump electrode 24, which may be covered with a porous protective layer (not illustrated), is situated on the major surface of sensor element 20 directly facing the measuring gas, which may be in an annular shape around a gas inlet opening 27. On the wall delimiting measuring space 23 and facing external pump electrode 24, there is a corresponding internal pump electrode 26, which also has an annular design, matching the annular geometry of measuring gas space 23. The two pump electrodes 24, 26 together form an electrochemical pump cell.

A measuring electrode 21 is located in measuring gas space 23 opposite internal pump electrode 26. It also has an annular design, for example. An associated reference electrode is situated in the air reference channel. The measuring electrode and reference electrode together form a Nernst cell, i.e., a concentration cell.

Inside measuring gas space 23, there is a porous diffusion barrier 28 upstream from internal pump electrode 26 and measuring electrode 21 in the direction of diffusion of the measuring gas. Porous diffusion barrier 28 forms a diffusion resistance regarding the gas diffusing to electrodes 21, 26. To ensure that thermodynamic equilibrium of the measuring gas components is established at the electrodes, all the electrodes used are made of a catalytically active material, for example, platinum, the electrode material of all electrodes being used as cermet to be sintered with the ceramic sheets in the known manner.

Heating element 30 integrated in the ceramic base body of sensor element 20 includes a resistance heater 32 embedded between insulation layers. The resistance heater is used for heating sensor element 20 to the required operating temperature.

Heating element 30 may include a first insulation layer 34 surrounding resistance heater 32 and may include two insulation layers 36 delimiting insulation layer 34 on its major surface.

Insulating layer 34 is made up of two thick layers, for example, which surround resistance heater 32 on the top and the bottom and includes the above-described ceramic insulating material. The two other insulating layers 36, which surround the above-mentioned insulation layer 34 and delimit it against the base ceramic, may be made of pure Al₂O₃ or a mixture of Al₂O₃ and an acid oxide.

Another example of a sensor element having a heating element which is insulated against the surrounding solid electrolyte material by the above-described ceramic insulating material is shown in FIG. 4. The same reference numerals denote the same components as in FIG. 3.

Insulating layers 34 containing the ceramic insulating material according to the exemplary embodiment and/or exemplary method of the present invention now do not directly surround resistance heater 32, but are situated between insulating layers 36, one of insulating layers 36 being in direct contact with resistance heater 32. This insulating layer 36 has two thick layers which are directly adjacent to resistance heater 32.

However, basically it is also possible to produce the entire heater insulation of a sensor element from the above-described ceramic insulating material.

The use of the ceramic insulating material is not limited to sensor elements for determining the oxygen content of combustion gases, but it may be used in any sensor elements on a solid electrolyte basis, regardless of their intended application or overall construction.

1-11. (canceled)

12. A ceramic insulating material for a sensor element for determining a concentration of a gas component in a gas mixture, comprising:
an alkaline earth-containing ceramic;
a hexaaluminate of the alkaline earth metal; and
at least one mixed compound of the alkaline earth metal having an acid oxide, wherein a molar ratio of hexaaluminate to a sum of mixed compounds in the ceramic insulating material is 1.3 to 4.0.

13. A ceramic insulating material for a sensor element for determining a concentration of a gas component in a gas mixtures, comprising:
an alkaline earth-containing ceramic;
a hexaaluminate of the alkaline earth metal; and
at least one mixed compound of the alkaline earth metal having an acid oxide, wherein the hexaaluminate of the alkaline earth metal and the at least one mixed compound in a ceramic matrix form separate phases.

14. The ceramic insulating material of claim 12, wherein the alkaline earth metal includes barium.

15. The ceramic insulating material of claim 12, wherein the acid oxide includes at least one of SiO₂, ZrO₂, V₂O₅, P₂O₅, and TiO₂.

16. The ceramic insulating material of claim 12, wherein the mixed compound is at least one of celsian and barium zirconate.

17. The ceramic insulating material of claim 12, further comprising: aluminum oxide.

18. The ceramic insulating material of claim 12, wherein the hexaaluminate of the alkaline earth metal in the ceramic insulating material is not greater than about 10 molar %.

19. The ceramic insulating material of claim 12, wherein its composition includes: 90-97 molar % corundum; 0.25-5.0 molar % celsian; and 1.5-8.0 molar % barium hexaaluminate.

20. The ceramic insulating material of claim 12, wherein its composition includes: 87.5-95 molar % corundum; 0.25-6.25 molar % celsian; 1.5-6.0 molar % barium hexaaluminate; and 0.25-2.0 molar % barium zirconate.

21. A ceramic sensor element for determining a gas components of a gas mixture, comprising:
a heating element, which includes an electric resistor and a ceramic insulation material surrounding the electric resistor;
wherein the ceramic insulation material includes one of (i) and (ii), which are as follows:
(i) an alkaline earth-containing ceramic,
a hexaaluminate of the alkaline earth metal, and
at least one mixed compound of the alkaline earth metal having an acid oxide, wherein a molar ratio of hexaaluminate to a sum of mixed compounds in the ceramic insulating material is 1.3 to 4.0; and
(ii) an alkaline earth-containing ceramic,
a hexaaluminate of the alkaline earth metal, and
at least one mixed compound of the alkaline earth metal having an acid oxide, wherein the hexaaluminate of the alkaline earth metal and the at least one mixed compound in a ceramic matrix form separate phases.

22. The ceramic sensor element of claim 21, wherein the heating element includes layers, and part of the layers contain aluminum oxide and another part of the layers are formed of the ceramic insulation material.
